(19) United States
(12) Patent Application Publication
(10) Pub. No.: US 2022/0156567 A1
(43) Pub. Date: May 19, 2022

(54) NEURAL NETWORK PROCESSING UNIT FOR HYBRID AND MIXED PRECISION COMPUTING

(71) Applicant: MediaTek Inc., Hsinchu (TW)

(72) Inventors: Chien-Hung Lin, Hsinchu (TW); Yi-Min Tsai, Hsinchu (TW); Chia-Lin Yu, Hsinchu (TW); Chi-Wei Yang, Hsinchu (TW)

(21) Appl. No.: 17/505,422

(22) Filed: Oct. 19, 2021

Related U.S. Application Data
(60) Provisional application No. 63/113,215, filed on Nov. 13, 2020.

(51) Int. Cl. G06N 3/063; G06N 3/04

(52) U.S. Cl. CPC G06N 3/063; G06N 3/04

(57) ABSTRACT

A neural network (NN) processing unit includes an operation circuit to perform tensor operations of a given layer of a neural network in one of a first number representation and a second number representation. The NN processing unit further includes a conversion circuit coupled to at least one of an input port and an output port of the operation circuit to convert between the first number representation and the second number representation. The first number representation is one of a fixed-point number representation and a floating-point number representation, and the second number representation is the other one of the fixed-point number representation and the floating-point number representation.

### CROSS-REFERENCE TO RELATED APPLICATIONS

This application claims the benefit of U.S. Provisional Application No. 63/113,215 filed on Nov. 13, 2020, the entirety of which is incorporated by reference herein.

### TECHNICAL FIELD

Embodiments of the invention relate to a neural network processing unit and deep neural network operations performed by the neural network processing unit.

### BACKGROUND

A deep neural network is a neural network with an input layer, an output layer, and one or more hidden layers between the input layer and the output layer. Each layer performs operations on one or more tensors. A tensor is a mathematical object that can be zero-dimensional (a.k.a. a scaler), one-dimensional (a.k.a. a vector), two-dimensional (a.k.a. a matrix), or multi-dimensional. The operations performed by the layers are numerical computations including, but not limited to: convolution, deconvolution, fully-connected operations, normalization, activation, pooling, resizing, element-wise arithmetic, concatenation, slicing, etc. Some of the layers apply filter weights to a tensor, such as in a convolution operation.

Tensors move from layer to layer in a neural network. Generally, a tensor produced by a layer is stored in local memory and is retrieved from the local memory by the next layer as input. The storing and retrieving of tensors as well as any applicable filter weights can use a significant amount of data bandwidth on a memory bus.

Neural network computing is computation-intensive and bandwidth-demanding. Modern computers typically use floating-point numbers with a large bit-width (e.g., 32 bits) in numerical computations for high accuracy. However, the high accuracy is achieved at the cost of high power consumption and high data bandwidth. It is a challenge to balance the need for low power consumption and low data bandwidth while maintaining an acceptable accuracy in neural network computing.

### SUMMARY

In one embodiment, a neural network (NN) processing unit includes an operation circuit to perform tensor operations of a given layer of a neural network in one of a first number representation and a second number representation. The NN processing unit further includes a conversion circuit coupled to at least one of an input port and an output port of the operation circuit to convert between the first number representation and the second number representation. The first number representation is one of a fixed-point number representation and a floating-point number representation, and the second number representation is the other one of the fixed-point number representation and the floating-point number representation.

In another embodiment, a neural network (NN) processing unit includes an operation circuit and a conversion circuit. The neural network processing unit is operative to select to enable or bypass the conversion circuit for input conversion of an input operand according to the operating parameters for a given layer of the neural network. The input conversion, when enabled, converts from a first number representation to a second number representation. The neural network processing unit is further operative to perform tensor operations on the input operand in the second number representation to generate an output operand in the second number representation, and select to enable or bypass the conversion circuit for output conversion of an output operand according to the operating parameters. The output conversion, when enabled, converts from the second number representation to the first number representation. The first number representation is one of a fixed-point number representation and a floating-point number representation, and the second number representation is the other one of the fixed-point number representation and the floating-point number representation.

In yet another embodiment, a system includes one or more floating-point circuits to perform floating-point tensor operations for one or more layers of the neural network and one or more fixed-point circuits to perform fixed-point tensor operations for other one or more layers of the neural network. The system further includes one or more conversion circuits coupled to at least one of the floating-point circuits and the fixed-point circuits to convert between a floating-point number representation and a fixed-point number representation.

Other aspects and features will become apparent to those ordinarily skilled in the art upon review of the following description of specific embodiments in conjunction with the accompanying figures.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating a system operative to perform neural network (NN) operations according to one embodiment.

FIG. 2 is a block diagram illustrating an example of an NN processing unit that includes a fixed-point circuit according to one embodiment.

FIG. 3 is a block diagram illustrating an example of an NN processing unit that includes a floating-point circuit according to one embodiment.

FIG. 4A and FIG. 4B are block diagrams illustrating NN processing units with different arrangements of converters according to some embodiments.

FIG. 5A and FIG. 5B are block diagrams illustrating NN processing units with a buffer memory according to some embodiments.

FIG. 6 is a block diagram illustrating an NN processing unit according to another embodiment.

FIG. 7 is a block diagram illustrating an NN processing unit according to yet another embodiment.

FIG. 8A and FIG. 8B are diagrams illustrating some time-sharing aspects of an NN processing unit according to some embodiments.

FIG. 9 is a flow diagram illustrating a method for hybrid-precision computing according to one embodiment.

FIG. 10 is a flow diagram illustrating a method for mixed-precision computing according to one embodiment.

FIG. 11 is a flow diagram illustrating a method for configurable tensor operations according to one embodiment.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a neural network (NN) processing unit including dedicated circuitry for hybrid-precision and mixed-precision computing for a multi-layer neural network. As used herein, the terms “hybrid-precision computing” and “mixed-precision computing” refer to neural network computing on numbers with different number representations, such as floating-point numbers and fixed-point numbers. In hybrid-precision computing, a layer may receive multiple input operands that include both floating-point numbers and fixed-point numbers. The computation performed on the input operands is in either floating-point or fixed-point; thus, a conversion is performed on one or more of the input operands such that all input operands have the same number representation. An input operand may be an input activation, filter weights, a feature map, etc. In mixed-precision computing, one or more layers in a neural network may compute in floating-point and another one or more layers may compute in fixed-point. The choice of number representation for each layer can have a significant impact on computation accuracy, power consumption, and data bandwidth.

The neural network operation performed by the NN processing unit is referred to as tensor operations. The NN processing unit performs tensor operations according to a DNN model. The DNN model includes a plurality of operation layers, also referred to as OP layers or layers. For each layer, the NN processing unit is configurable by operating parameters to perform conversion and computation in a number representation. The NN processing unit provides a dedicated hardware processing path for executing tensor operations and conversion between the different number representations. The hardware support for both floating-point numbers and fixed-point numbers enables a wide range of artificial intelligence (AI) applications to run on edge devices.

Fixed-point arithmetic is widely used in applications where latency requirements outweigh accuracy. A fixed-point number can be defined by a bit-width and a position of the radix point. Fixed-point arithmetic is easy to implement in hardware and more efficient to compute, but less accurate when compared with floating-point arithmetic. The term “fixed-point representation” as used herein refers to a number representation having a fixed number of bits for an integer part and a fractional part. A fixed-point representation may optionally include a sign bit.

On the other hand, floating-point arithmetic is widely used in scientific computations or in applications where accuracy is a main concern. The term “floating-point representation” as used herein refers to a number representation having a mantissa (also referred to as “coefficient”) and an exponent. A floating-point representation may optionally include a sign bit. Examples of the floating-point representation include, but are not limited to, IEEE 754 standard formats such as 16-bit, 32-bit, 64-bit floating-point numbers, or other floating-point formats supported by some processors.

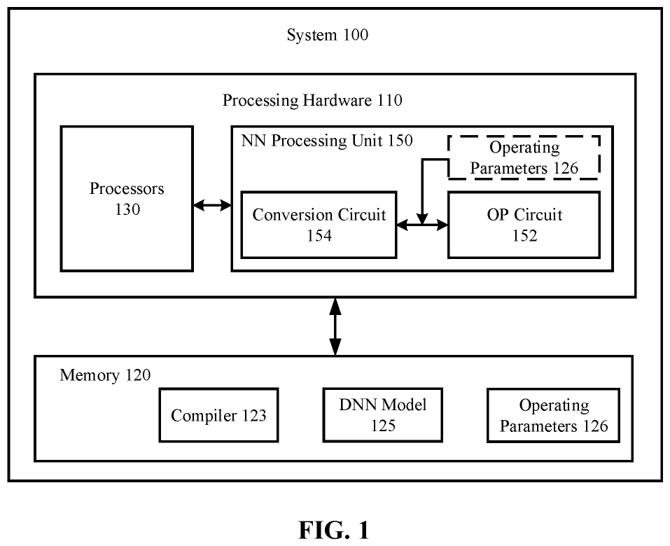

FIG. 1 is a block diagram illustrating a system 100 operative to perform tensor operations according to one embodiment. The system 100 includes processing hardware 110 which further includes one or more processors 130 such as central processing units (CPUs), graphics processing units (GPUs), digital processing units (DSPs), field-programmable gate arrays (FPGAs), and other general-purpose processors and/or special-purpose processors. The processors 130 are coupled to a neural network (NN) processing unit 150. The NN processing unit 150 is dedicated to neural network operations; e.g., tensor operations. Examples of the tensor operations include, but are not limited to: convolution, deconvolution, fully-connected operations, normalization, activation, pooling, resizing, element-wise arithmetic, concatenation, slicing, etc.

The NN processing unit 150 includes at least an operation (OP) circuit 152 coupled to at least a conversion circuit 154. The OP circuit 152 performs mathematical computations including, but not limited to, one or more of: add, subtract, multiply, multiply-and-add (MAC), function F(x) evaluation, and any of the aforementioned tensor operations. The OP circuit 152 may include one or more of the following function units: an adder, a subtractor, a multiplier, a function evaluator, and a multiply-and-accumulate (MAC) circuit. Non-limiting examples of a function evaluator include tanh(X), sigmoid(X), ReLu(X), GeLU(X), etc. The OP circuit 152 may include a floating-point circuit or a fixed-point circuit. Alternatively, the OP circuit 152 may include both a floating-point circuit and a fixed-point circuit. The floating-point circuit includes one or more floating-point functional units to carry out the aforementioned tensor operations in floating-point. The fixed-point circuit includes one or more fixed-point functional units to carry out the aforementioned tensor operations in fixed-point. In an embodiment where the NN processing unit 150 includes multiple OP circuits 152, different OP circuits 152 may include hardware for different number representations; e.g., some OP circuits 152 may include floating-point circuits, and some other OP circuits 152 may include fixed-point circuits.

The conversion circuit 154 includes dedicated hardware for converting between floating-point numbers and fixed-point numbers. The conversion circuit 154 may be a floating-point to fixed-point converter, a fixed-point to floating-point converter, a combined converter that includes both a floating-point to fixed-point converter and a fixed-point to floating-point converter, or a converter that is configurable to convert from floating-point to fixed-point or from fixed-point to floating-point. The conversion circuit 154 may include conversion hardware such as one or more of: an adder, a multiplier, a shifter, etc. The conversion hardware may also include a detector or counter for leading one/zero in the case of a floating-point number. The conversion circuit 154 may further include a multiplexer having one conversion path connected to the conversion hardware and a bypass path to allow a non-converted operand to bypass conversion. A select signal can be provided to the multiplexer to select either enabling or bypassing the input and/or output conversion for each layer. In an embodiment where the NN processing unit 150 includes multiple conversion circuits 154, some conversion circuits 154 may convert from floating-point to fixed-point and some other conversion circuits 154 may convert from fixed-point to floating-point. Moreover, some conversion circuits 154 may be coupled to output ports of corresponding OP circuits 152, and some other conversion circuits 154 may be coupled to input ports of corresponding OP circuits 152.

The processing hardware 110 is coupled to a memory 120, which may include memory devices such as dynamic random access memory (DRAM), static random access memory (SRAM), flash memory, and other non-transitory machine-readable storage media; e.g., volatile or non-volatile memory devices. To simplify the illustration, the memory 120 is represented as one block; however, it is understood that the memory 120 may represent a hierarchy of memory components such as cache memory, local memory to the NN processing unit 150, system memory, solid-state or magnetic storage devices, etc. The processing hardware 110 executes instructions stored in the memory 120 to perform operating system functionalities and run user applications. For example, the memory 120 may store an NN compiler 123, which can be executed by the processors 130 to compile a source program into executable code for the processing hardware to execute operations according to a DNN model 125. The DNN model 125 can be represented by a computational graph that includes multiple layers, including an input layer, an output layer, and one or more hidden layers in between. The DNN model 125 may be trained to have weights associated with one or more of the layers. The NN processing unit 150 performs tensor operations according to the DNN model 125 with the trained weights. The tensor operations may include hybrid-precision computing and/or mixed-precision computing. The memory 120 further stores operating parameters 126 for each layer of the DNN model 125 to indicate whether to enable or bypass conversion of number representation for the layer.

In an alternative embodiment, the operating parameters 126 may be stored locally in, or otherwise accessible to, the NN processing unit 150 in the form of a finite state machine. The NN processing unit 150 may operate according to the operating parameters 126 in the finite state machine to execute the tensor operations.

For example, under constraints of execution time or power consumption, the NN processing unit 150 may be configured to perform some or all of computation-demanding tasks (e.g., matrix multiplications) in fixed-point arithmetic. If a layer receives one input operand in floating-point and another input operand in fixed-point, the conversion circuit 154 can convert the floating-point operand to fixed-point at runtime for the OP circuit 152 to perform fixed-point multiplications.

In some embodiments, the memory 120 may store instructions which, when executed by the processing hardware 110, cause the processing hardware 110 to perform mixed and/or hybrid-precision computing according to the DNN model 125 and the operating parameters 126.

Before proceeding to additional embodiments, it is helpful to describe the conversions between floating-point and fixed-point. The relationship between a floating-point vector Float[i] and a corresponding fixed-point vector Fixed[i], i=[1,N] can be described by the formula: Float[i]=S×(Fixed[i]+O), where S is a scaling factor and O is an offset. The conversion is symmetric when O is zero; it is asymmetric when O is non-zero. The scaling factor and the offset may be provided by offline computations. In some embodiments, the scaling factor may be computed on the fly; i.e., during the inference phase of NN operations, based on the respective ranges of the floating-point numbers and the fixed-point numbers. In some embodiments, the offset may be computed on the fly based on the distribution of the floating-point numbers and the fixed-point numbers around zero. For example, when the distribution of the numbers is not centered around zero, using asymmetric conversion can reduce the quantization error.

The conversion circuit 154 converts the input operands for the OP circuit 152 such that the numerical values operated on by the OP circuit 152 have the same number representation, which includes the same bit-width for the mantissa and the exponent in the case of a floating-point number and the same bit-widths for the integer portion and the fractional portion in the case of a fixed-point number. Moreover, the same number representation includes the same offset when the number range is not centered at zero. Additionally, the same number representation includes the same sign or unsigned representation.

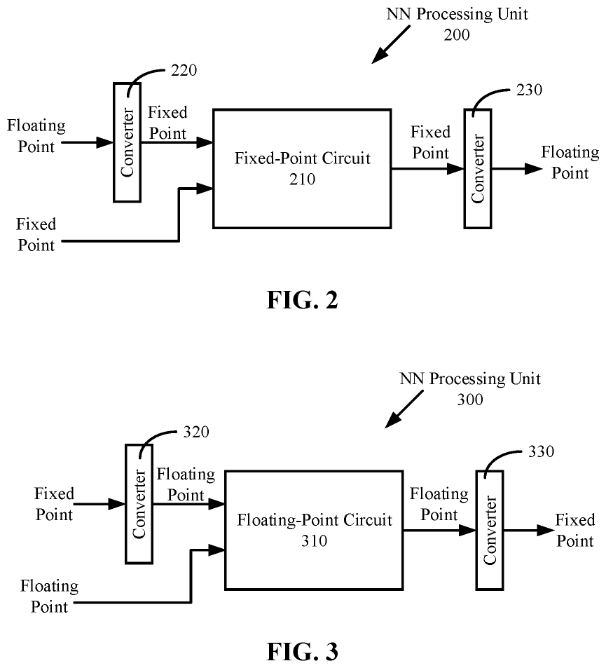

FIG. 2 is a block diagram illustrating an example of an NN processing unit 200 that includes a fixed-point circuit 210 according to one embodiment. The NN processing unit 200 may be an example of the NN processing unit 150 in FIG. 1. The fixed-point circuit 210, which is an example of the OP circuit 152 (FIG. 1), natively supports fixed-point representation. The fixed-point circuit 210 has an input port coupled to an input converter 220 and an output port coupled to an output converter 230. The NN processing unit 200 can perform hybrid-precision computing, that is, when the input operands to a DNN layer have different number representations. For example, input operands received from different input channels may use different number presentations; e.g., floating-point and fixed-point. As another example, a layer may receive an input activation in a number representation different from that of the layer's filter weights. The NN processing unit 200 can also perform fixed-point tensor operations without input conversion, e.g., when the input operands are in fixed-point.

When the NN processing unit 200 receives a first input operand in floating-point and a second input operand in fixed point for a given layer, the input converter 220 converts the floating-point operand to fixed-point. The fixed-point circuit 210 then performs fixed-point calculations on the converted first input operand and the second input operand to produce an output operand in fixed-point. The output converter 230 may be bypassed or may convert the output operand to floating-point, depending on the number representation required by the DNN output or the subsequent layer of the DNN.

Thus, the input converter 220 and/or the output converter 230 may be selectively enabled or bypassed for each layer of a DNN. Although FIG. 2 shows that the NN processing unit 200 includes both the input converter 220 and the output converter 230, in an alternative embodiment the NN processing unit 200 may include one of the input converter 220 and the output converter 230. Moreover, FIG. 2 shows the input converter 220 and the output converter 230 as two separate components; in some embodiments, the input converter 220 and the output converter 230 may be combined into a combined converter that converts from floating-point to fixed-point and/or from fixed-point to floating-point as needed. Such a combined converter may be an example of the conversion circuit 154 in FIG. 1.

FIG. 3 is a block diagram illustrating an example of an NN processing unit 300 that includes a floating-point circuit 310 according to one embodiment. The NN processing unit 300 may be an example of the NN processing unit 150 in FIG. 1. The floating-point circuit 310, which is an example of the OP circuit 152 (FIG. 1), natively supports floating-point representation. The floating-point circuit 310 has an input port coupled to an input converter 320 and an output port coupled to an output converter 330. The NN processing unit 300 can perform hybrid-precision computing when the input operands to a DNN layer have different number representations. The input converter 320 converts fixed-point to floating-point, and the output converter 330 converts floating-point to fixed-point. Similar to the converters 220 and 230 in FIG. 2, the input converter 320 and/or the output converter 230 may be selectively enabled or bypassed for each layer of a DNN. In an alternative embodiment, the NN processing unit 300 may include one of the input converter 220 and the output converter 230. Moreover, in some embodiments, the input converter 320 and the output converter 330 may be combined into a combined converter that converts from floating-point to fixed-point and/or from fixed-point to floating-point as needed. Such a combined converter may be an example of the conversion circuit 154 in FIG. 1.

In addition to the hybrid-precision computations as mentioned in connection with FIG. 2 and FIG. 3, the processing hardware 110 (FIG. 1) supports mixed-precision computing, in which one layer of a neural network computes in fixed-point and another layer computes in floating-point. In one embodiment, the processing hardware 110 may include both the NN processing unit 200 to perform fixed-point operations for some layers and the NN processing unit 300 to perform floating-point operations for some other layers. In another embodiment, the processing hardware 110 may use the processors 130 in combination with either the NN processing unit 200 or the NN processing unit 300 to perform the hybrid and/or mixed-precision computing.

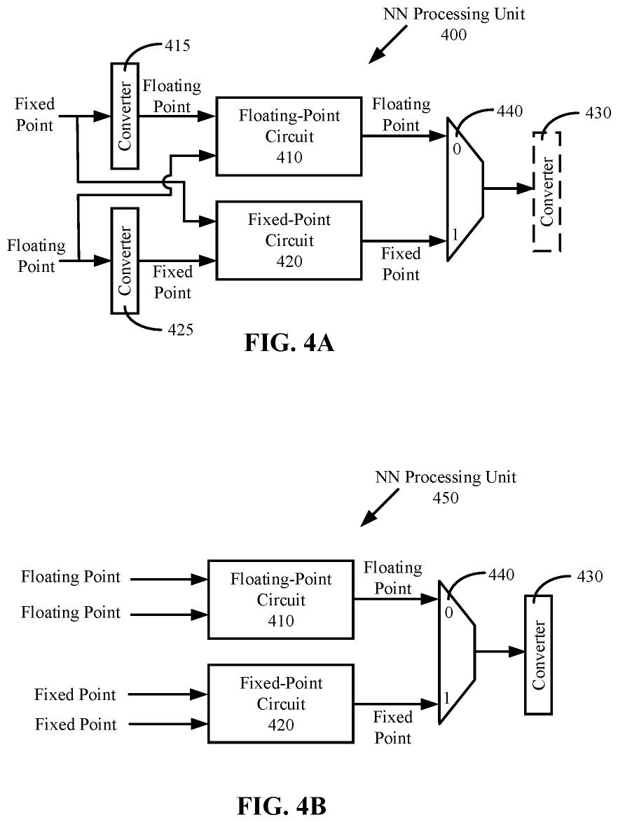

FIG. 4A and FIG. 4B are block diagrams illustrating some examples of the NN processing unit 150 in FIG. 1 according to some embodiments. In FIG. 4A, an NN processing unit 400 includes both a floating-point circuit 410 for floating-point tensor operations and a fixed-point circuit 420 for fixed-point tensor operations. The input ports of the floating-point circuit 410 and the fixed-point circuit 420 are coupled to input converters 415 and 425, respectively, and their output ports are coupled, in parallel, to an output converter 430 via a multiplexer 440. The input converter 415 converts fixed-point to floating-point, and the input converter 425 converts from floating-point to fixed-point. The multiplexer 440 selects the output from either the floating-point circuit 410 or the fixed-point circuit 420, depending on which circuit is in use for a current layer. The selected output is sent to the output converter 430, which can convert the output to a required number representation; i.e., from floating-point to fixed-point and from fixed-point to floating-point as needed. Each of the converters 415, 425, and 430 can be selectively enabled or bypassed for each layer. Similar to FIG. 2 and FIG. 3, the converters 415, 425, and 430 can be implemented by a combined converter that converts number representations in both directions. In an alternative embodiment, the NN processing unit 400 may include only the input converters 415 and 425 but not the output converter 430. In yet another embodiment illustrated in FIG. 4B, an NN processing unit 450 includes only the output converter 430 but not the input converters 415 and 425.

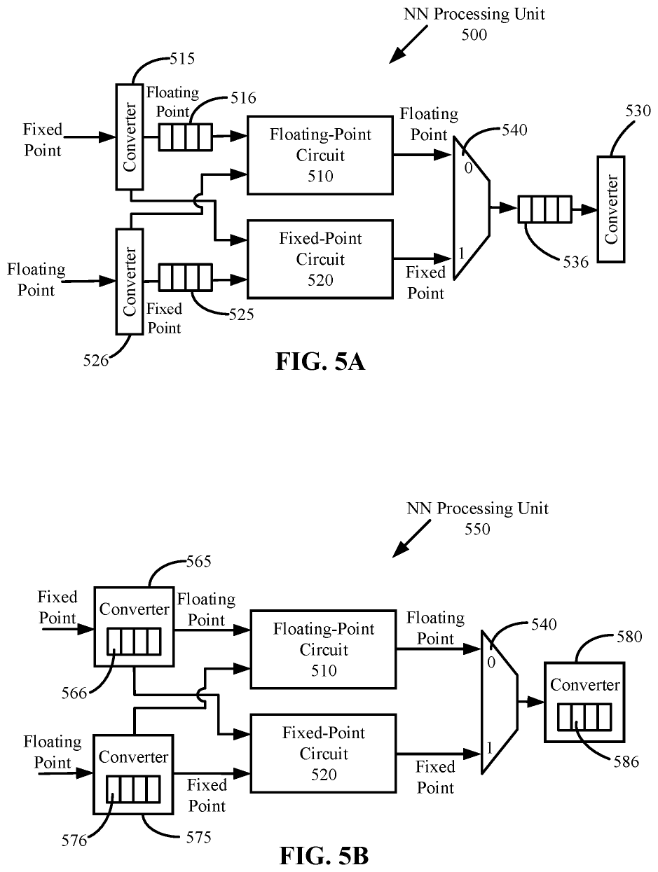

FIG. 5A and FIG. 5B are block diagrams illustrating additional examples of the NN processing unit 150 in FIG. 1 according to some embodiments. FIG. 5A shows an NN processing unit 500, which includes both a floating-point circuit 510 for floating-point tensor operations and a fixed-point circuit 520 for fixed-point tensor operations. The output ports of the floating-point circuit 510 and the fixed-point circuit 520 are coupled, in parallel, to a multiplexer 540, which can select either the floating-point output or the fixed-point output. The floating-point circuit 510 may compute a layer of a neural network in floating-point and the fixed-point circuit 520 may compute another layer of the neural network in fixed-point. The NN processing unit 500 further includes converters 515, 525, and 530, which perform the same conversion functions as the converters 415, 425, and 430 (FIG. 4), respectively. Additionally, the converters 515, 525, and 530 are coupled to a buffer memory. The buffer memory may include buffers 516, 526, and 536 for rate control or compensation. For example, the converters 515, 525, and 530 may handle one number per cycle, and the circuits 510 and 520 may output 512 numbers at a time every 512 cycles. Each buffer (516, 526, or 536) is between a floating/fixed-point circuit and a corresponding converter.

In the example of FIG. 5B, an NN processing unit 550 also includes buffers 566, 576, and 586 that are internal to the respective converters 565, 575, and 585 to provide rate control or compensation. By buffering the non-converted input, the buffers 566 and 576 may enable the respective input converters (515 and 525) to determine, during the operations of a given layer, a scaling factor for conversion between the number representations. That is, the input converters 515 and 525 can compute, on the fly, the scaling factor between a fixed-point representation and a corresponding floating-point representation. The input converters 515 and 525 may additionally compute, on the fly, the offset between the fixed-point representation and the corresponding floating-point representation. The scaling factor and the offset have been described in connection with FIG. 1 regarding the relationship between a fixed-point representation and a corresponding floating-point representation of a vector.

Referring to FIG. 5A, the converters 515, 525, and 530 can be implemented by a combined converter that converts number representations in both directions. In an alternative embodiment, the NN processing unit 500 or 550 may include only the input converters and their corresponding buffers, but not the output converter and its corresponding buffer. In yet another embodiment, the NN processing unit 500 or 550 may include only the output converter and its corresponding buffer but not the input converters and their corresponding buffers.

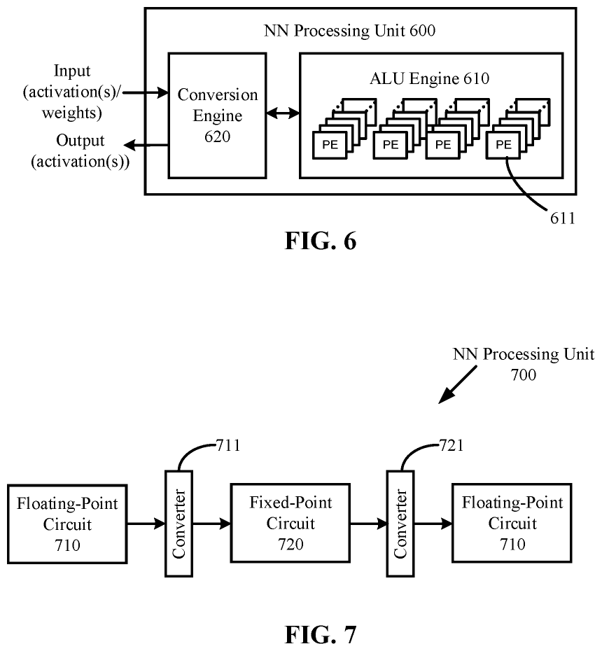

FIG. 6 is a block diagram illustrating an NN processing unit 600 according to one embodiment. The NN processing unit 600 is an example of the NN processing unit 150 in FIG. 1. The NN processing unit 600 includes an arithmetic logic unit (ALU) engine 610, which includes an array of processing elements 611. The ALU engine 610 is an example of the OP circuit 152 in FIG. 1. Each processing element 611 may be instructed to perform either floating-point or fixed-point computations for any given layer of a DNN. The ALU engine 610 is coupled to a conversion engine 620, which includes circuitry to convert from floating-point to fixed-point and from fixed-point to floating-point. The conversion engine 620 is an example of the conversion circuit 154 in FIG. 1.

In one embodiment, the processing elements 611 are interconnected to optimize accelerated tensor operations such as convolutional operations, fully-connected operations, activation, pooling, normalization, element-wise mathematical computations, etc. In some embodiments, the NN processing unit 600 includes a local memory (e.g., SRAM) to store operands that move from one layer to the next. The processing elements 611 may further include multipliers and adder circuits, among others, for performing mathematical operations such as multiply-and-accumulate (MAC) operations and other tensor operations.

FIG. 7 is a block diagram illustrating an NN processing unit 700 according to yet another embodiment. The NN processing unit 700 is an example of the NN processing unit 150 in FIG. 1. The NN processing unit 700 includes a floating-point circuit 710, a fixed-point circuit 720, and a floating-point circuit 730 coupled to one another in series. Each of the circuits 710, 720, and 730 may perform tensor operations for a different layer of a neural network. A converter 711 is between the floating-point circuit 710 and the fixed-point circuit 720 to convert from floating-point to fixed-point. Another converter 721 is between the fixed-point circuit 720 and the floating-point circuit 730 to convert from fixed-point to floating-point. An alternative embodiment of the NN processing unit 700 may include one or more floating-point circuits and one or more fixed-point circuits coupled to one another in series. This alternative embodiment may further include one or more conversion circuits, and each conversion circuit may be coupled to a floating-point circuit and/or a fixed-point circuit to convert between a floating-point number representation and a fixed-point number representation. Each of the floating/fixed-point circuits may perform tensor operations for a layer of a neural network.

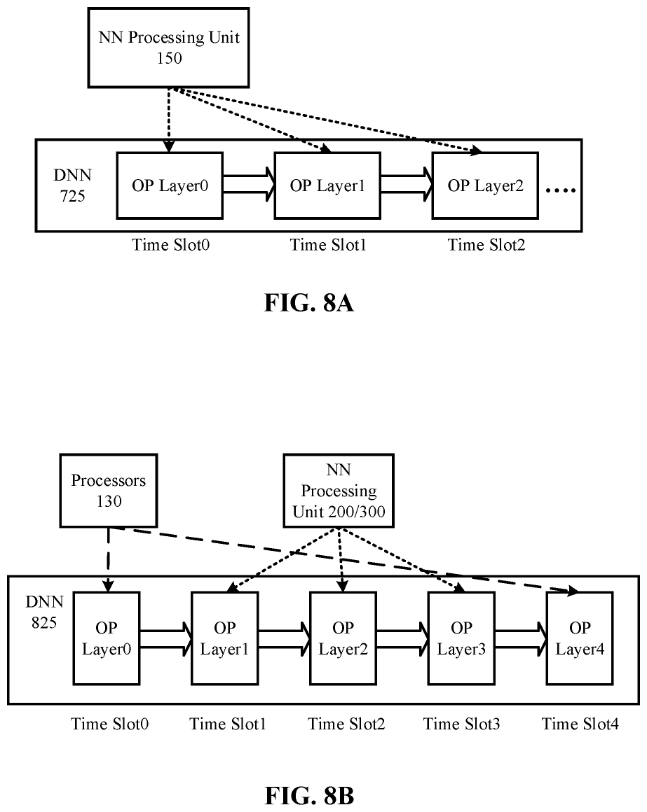

FIG. 8A is a diagram illustrating a time-sharing aspect of the NN processing unit 150 in FIG. 1 according to one embodiment. Referring also to FIG. 1, the processing hardware 110 may include one NN processing unit 150 that is time-shared by multiple layers of a DNN 725; e.g., layer 0 at time slot 0, layer 1 at time slot 1, and layer 2 at time slot 2, etc. The time-shared NN processing unit 150 can be any of the aforementioned NN processing units illustrated in FIGS. 1-6. In one embodiment, the NN processing unit 150 may have a different configuration for different layers and different time slots; e.g., hybrid-precision for layer 0 (time slot 0) and fixed-point computations for layers 1 and 2 (time slots 1 and 2). Different embodiments illustrated in FIGS. 1-6 may support different combinations of the number representations across the layers. Within each layer, the conversion circuit 154 may be selectively enabled or bypassed to feed the OP circuit 152 with numbers in the number representations according to the operating parameters of the DNN 725.

In another embodiment, the processing hardware 110 may include multiple NN processing units 150, and each NN processing unit 150 may be any of the aforementioned NN processing units illustrated in FIGS. 1-6. Each NN processing unit 150 may compute a different layer of a neural network. The multiple NN processing units 150 may include the same hardware (e.g., N copies of the same NN processing units). Alternatively, the processing hardware 110 may include a combination of any of the aforementioned NN processing units illustrated in FIGS. 1-6. In one embodiment, the operating parameters may indicate the mapping from each layer of the DNN to one of the NN processing units.

FIG. 8B is a diagram illustrating a usage example of the NN processing unit 200 in FIG. 2 according to one embodiment. An analogous usage example can also be provided with reference to the NN processing unit 300 in FIG. 3. Referring to FIG. 2, the NN processing unit 200 includes the fixed-point circuit 210 and converters 220 and 230. In this example, a DNN 825 including five OP layers (layer0-layer4) is executed by the NN processing unit 200. The processors 130 (e.g., a CPU) at time slot0 computes layer0 in floating-point and generates a layer0 floating-point output.

Layer1, layer2, and layer3 compute in fixed-point. The input converter 220 converts the layer0 floating-point output into fixed-point numbers, and the fixed-point circuit 210 multiplies these converted fixed-point numbers by fixed-point weights of layer1 to generate a layer1 fixed-point output. The output converter 230 is bypassed for layer1.

For layer2 computations, the input converter 220 is bypassed, and the fixed-point circuit 210 multiplies the layer1 fixed-point output by fixed-point weights of layer2 to generate a layer2 fixed-point output. The output converter 230 is bypassed for layer2.

For layer3 computations, the input converter 220 is bypassed, and the fixed-point circuit 210 multiplies the layer2 fixed-point output by fixed-point weights of layer3 to generate a fixed-point output. The output converter 230 converts the fixed-point output into layer3 floating-point numbers. Layer4 computes in floating-point. The processors 130 at time slot4 operate on layer3 floating-point numbers to perform floating-point operations and generates a final floating-point output.

In the above example, the NN processing unit 200 bypasses the output conversion for layer 1 of the consecutive layers (layer1-layer3), the input conversion for layer3 of the consecutive layers (layer1-layer3), and both the input conversion and the output conversion for the intermediate layer (layer2). Moreover, the fixed-point operations of consecutive layers are performed by the dedicated hardware in the NN processing unit 200 without utilizing processors outside the NN processing unit 200 (e.g., the processors 130). The NN processing unit 200 performs hybrid-precision tensor operations for layer1 in which the input activation is received from the processors 130 (layer0) in floating-point. The execution of the entire DNN 825 includes both hybrid-precision and mixed-precision computing. The mixed precision computing includes the floating-point operations (layer0 and layer4) and the fixed-point operations (layer1-layer3). The use of the fixed-point circuit 210 and the hardware converters 220 and 230 can significantly accelerate the fixed-point computations with low power consumption. For computations that require high accuracy, the processors 130 can perform floating-point operations and conversions of number representations by executing software instructions. The layers processed by the NN processing unit 200 may include consecutive layers and/or non-consecutive layers.

The above description regarding the NN processing unit 200 can be analogously applied to the NN processing unit 300 in FIG. 3 by switching the floating-point and the fixed-point. Referring to FIG. 3, the NN processing unit 300 includes the floating-point circuit 310 and the converters 320 and 330. In this usage example, the NN processing unit 300 computes layer1-layer 3 in floating-point and the processors 130 computers layer0 and layer4 in fixed-point. The floating-point operations of consecutive layers are performed by the dedicated hardware in the NN processing unit 300 without utilizing processors outside the NN processing unit 300 (e.g., the processors 130).

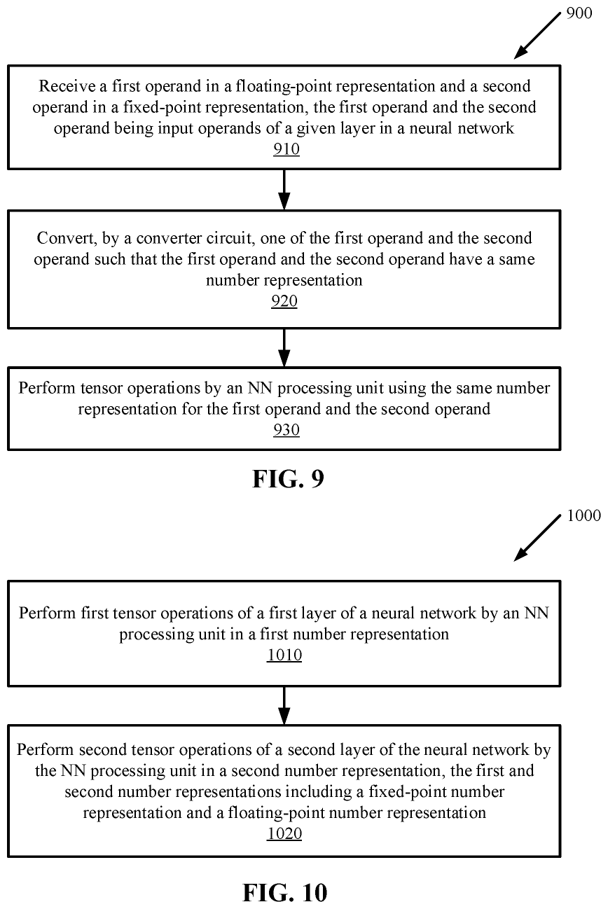

FIG. 9 is a flow diagram illustrating a method 900 for mixed-precision computing according to one embodiment. The method 900 may be performed by the system 100 of FIG. 1 including any NN processing unit in FIGS. 1-7.

The method 900 begins at step 910 when the NN processing unit receives a first operand in a floating-point representation and a second operand in a fixed-point representation. The first operand and the second operand are input operands of a given layer in a neural network. At step 920, a converter circuit converts one of the first operand and the second operand such that the first operand and the second operand have the same number representation. At step 930, the NN processing unit performs tensor operations using the same number representation for the first operand and the second operand.

FIG. 10 is a flow diagram illustrating a method 1000 for hybrid-precision computing according to one embodiment. The method 1000 may be performed by the system 100 of FIG. 1 including any NN processing unit in FIGS. 1-7.

The method 1000 begins at step 1010 when the NN processing unit performs first tensor operations of a first layer of a neural network in a first number representation. At step 1020, the NN processing unit performs second tensor operations of a second layer of the neural network in a second number representation. The first and second number representations include a fixed-point number representation and a floating-point number representation.

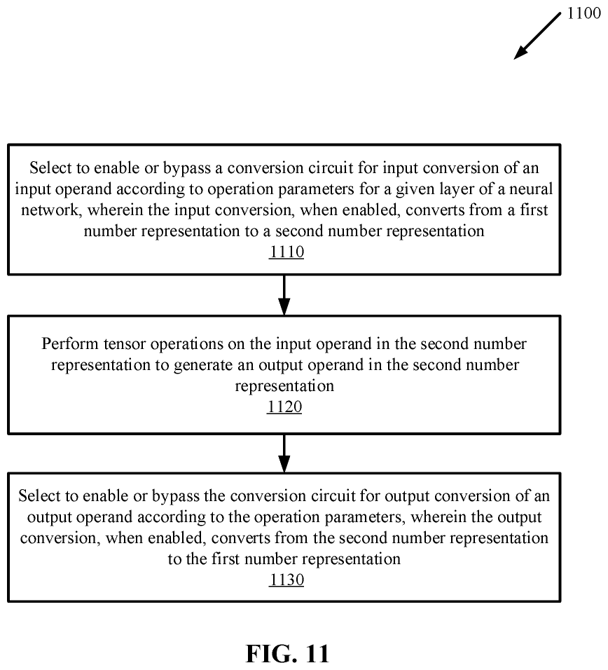

FIG. 11 is a flow diagram illustrating a method for configurable tensor operations according to one embodiment. The method 1100 may be performed by the system 100 of FIG. 1 including any of the aforementioned NN processing units.

The method 1100 begins at step 1110 when the NN processing unit selects to enable or bypass a conversion circuit for input conversion of an input operand according to operating parameters for a given layer of a neural network. The input conversion, when enabled, converts from a first number representation to a second number representation. At step 1120, the NN processing unit performs tensor operations on the input operand in the second number representation to generate an output operand in the second number representation. At step 1130, the NN processing unit selects to enable or bypass the conversion circuit for output conversion of an output operand according to the operating parameters. The output conversion, when enabled, converts from the second number representation to the first number representation. In one embodiment, the NN processing unit may use a select signal to a multiplexer to select the enabling or bypassing of the conversion circuit.

The operations of the flow diagrams of FIGS. 9-11 have been described with reference to the exemplary embodiments of FIGS. 1-7. However, it should be understood that the operations of the flow diagrams of FIGS. 9-11 can be performed by embodiments of the invention other than the embodiments of FIGS. 1-7, and the embodiments of FIGS. 1-7 can perform operations different than those discussed with reference to the flow diagrams. While the flow diagrams of FIGS. 9 -11 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A neural network processing unit, comprising:
an operation circuit to perform tensor operations of a given layer of a neural network in one of a first number representation and a second number representation; and
a conversion circuit coupled to at least one of an input port and an output port of the operation circuit to convert between the first number representation and the second number representation,
wherein the first number representation is one of a fixed-point number representation and a floating-point number representation, and the second number representation is the other one of the fixed-point number representation and the floating-point number representation.

2. The neural network processing unit of claim 1, wherein the conversion circuit, according to operating parameters for the given layer of the neural network, is configurable to be coupled to one or both of the input port and the output port of the operation circuit.

3. The neural network processing unit of claim 1, wherein the conversion circuit, according to operating parameters for the given layer of the neural network, is configurable to be enabled or bypassed for one or both input conversion and output conversion.

4. The neural network processing unit of claim 1, wherein the neural network processing unit is operative to perform hybrid-precision computing on a first input operand and a second input operand of the given layer, the first input operand and the second input operand having different number representations.

5. The neural network processing unit of claim 1, wherein the neural network processing unit is operative to perform mixed-precision computing in which computation in a first layer of the neural network is performed in the first number representation and computation in a second layer of the neural network is performed the second number representation.

6. The neural network processing unit of claim 1, wherein the neural network processing unit is time-shared among multiple layers of the neural network by operating on one layer at a time.

7. The neural network processing unit of claim 1, further comprising:
a buffer memory to buffer non-converted input for the converter circuit to determine, during operations of the given layer of the neural network, a scaling factor for conversion between the first number representation and the second number representation.

8. The neural network processing unit of claim 1, further comprising:
a buffer coupled between the converter circuit and the operation circuit.

9. The neural network processing unit of claim 1, wherein the operation circuit includes a fixed-point circuit to compute a layer of the neural network in fixed-point and a floating-point circuit to compute another layer of the neural network in floating-point.

10. The neural network processing unit of claim 1, wherein the neural network processing unit is coupled to one or more processors that are operative to perform operations of one or more layers of the neural network in the first number representation.

11. The neural network processing unit of claim 1, further comprising:
a plurality of operation circuits including one or more fixed-point circuits and floating-point circuits, different ones of the operation circuits operative to compute different layers of the neural network; and
one or more of the conversion circuits coupled to the operation circuits.

12. The neural network processing unit of claim 1, wherein the operation circuit further comprises one or more of:
an adder, a subtractor, a multiplier, a function evaluator, and a multiply-and-accumulate (MAC) circuit.

13. A neural network processing unit comprising:
an operation circuit; and
a conversion circuit, the neural network processing unit operative to:
select to enable or bypass the conversion circuit for input conversion of an input operand according to operating parameters for a given layer of the neural network, wherein the input conversion, when enabled, converts from a first number representation to a second number representation;
perform tensor operations on the input operand in the second number representation to generate an output operand in the second number representation; and
select to enable or bypass the conversion circuit for output conversion of an output operand according to the operating parameters, wherein the output conversion, when enabled, converts from the second number representation to the first number representation,
wherein the first number representation is one of a fixed-point number representation and a floating-point number representation, and the second number representation is the other one of the fixed-point number representation and the floating-point number representation.

14. The neural network processing unit of claim 13, wherein the neural network processing unit is operative to:
perform, for another given layer of the neural network, additional tensor operations on another input operand in the first number representation to generate another output operand in the first number representation.

15. The neural network processing unit of claim 13, wherein the neural network processing unit is time-shared among multiple layers of the neural network by operating on one layer at a time.

16. A system comprising:
one or more floating-point circuits to perform floating-point tensor operations for one or more layers of the neural network;
one or more fixed-point circuits to perform fixed-point tensor operations for other one or more layers of the neural network; and
one or more conversion circuits coupled to at least one of the floating-point circuits and the fixed-point circuits to convert between a floating-point number representation and a fixed-point number representation.

17. The system of claim 16, wherein the one or more floating-point circuits and the one or more fixed-point circuits are coupled to one another in a series according to a predetermined order.

18. The system of claim 16, wherein output ports of one of the floating-point circuits and one of the fixed-point circuits are coupled, in parallel, to a multiplexer.

19. The system of claim 16, wherein the one or more conversion circuits includes a floating-point to fixed-point converter that is coupled to an input port of a fixed-point circuit or an output port of a floating-point circuit.

20. The system of claim 16, wherein the one or more conversion circuits includes a fixed-point to floating-point converter that is coupled to an input port of a floating-point circuit or an output port of a fixed-point circuit.
